(19) United States
(12) Patent Application Publication
(10) Pub. No.: US 2005/0225665 A1
(43) Pub. Date: Oct. 13, 2005

(54) Digital camera module with controlled disabling

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry Co., LTD., Tu-Cheng City (TW)

(21) Appl. No.: 11/070,799

(22) Filed: Mar. 2, 2005

(30) Foreign Application Priority Data
Apr. 9, 2004 (TW) 93205424

(51) Int. Cl. H04N 5/262

(52) U.S. Cl. 348/363

(57) ABSTRACT

A digital camera module (100) for a portable electronic device includes an image-obtaining device (10) for obtaining images, a power source (105), a shielding apparatus (201), and a controlling device (20). The image-obtaining device includes a printed circuit board (104) with an image sensor (103) thereon. The shielding apparatus comprises a motor (2011), an arbor (2013), and a covering (2012). The arbor is rotatably mounted on the motor and attached to the covering. The covering is rotated by the arbor when the motor is activated. The power source is electrically connected with and provides power supply to the printed circuit board. The controlling device is connected with the motor and the power source in series, and controls the power supply from the power source to the motor. When the controlling device is switched on, the image-obtaining device is effectively disabled. The digital camera module thus helps prevent unauthorized use thereof.

### BACKGROUND OF THE INVENTION

1. Field of the Invention

The present invention generally relates to digital camera modules, and more particularly to a digital camera module used in portable electronic devices such as mobile phones and PDAs (Personal Digital Assistants).

2. Prior Art

Currently, digital camera modules are widely used in a variety of portable electronic devices. Most portable electronic devices are becoming progressively more miniaturized over time, and digital camera modules are correspondingly becoming smaller and smaller. For example, a digital camera is now widely available as a feature of a mobile phone. However, the small size of a contemporary digital camera module makes it easy for a user to surreptitiously take photographs. Many institutions such as art galleries and banks prohibit photo taking for security and safety reasons. Yet because of the small size of the digital camera module, it is difficult for staff or other people to be vigilant of unauthorized use of the corresponding portable electronic device.

Therefore, a digital camera module that can overcome the above-described problems is desired.

### SUMMARY OF THE INVENTION

Accordingly, an object of the present invention is to provide a digital camera module which can help prevent unauthorized use thereof.

To achieve the above-mentioned object, in an exemplary embodiment of the present invention, a digital camera module for a portable electronic device includes an image-obtaining device for obtaining images, a power source, a shielding apparatus, and a controlling device. The image-obtaining device includes a printed circuit board with an image sensor attached thereon. The shielding apparatus comprises a motor, an arbor, and a covering. The arbor is rotatably mounted on the motor and attached to the covering. The covering is rotated by the arbor when the motor is activated. The power source is electrically connected with and provides power supply to the printed circuit board. The controlling device is electrically connected with the motor and the power source in series, and controls the power supply from the power source to the motor. Once the controlling device is switched on, the power source provides power to the motor immediately. The motor is activated and rotates the arbor, and the arbor rotates the covering until the covering covers the lens structure of the image-obtaining device. Thus the photo-taking function of the digital camera module is ineffectual because no external light can reach the image-obtaining device.

In another embodiment of the present invention, a digital camera module for a portable electronic device includes an image-obtaining device for obtaining images, a power source, and a controlling device. The image-obtaining device includes a printed circuit board with an image sensor attached thereon. The controlling device is electrically connected with the image-obtaining device and the power source in series, so that the controlling device controls power supply from the power source to the image-obtaining device. Once the controlling device is switched on, the power source stops providing power to the image-obtaining device immediately. Thus the photo-taking function of the digital camera module is ineffectual, because the image-obtaining device is disabled.

In each of the above-described embodiments of the present invention, the controlling device can be voluntarily switched off by the user, or switched off by the user at the behest of a member of staff of secured premises. Either way, the digital camera module is made ineffectual for the time being.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic diagram of electrical and physical relationships between components of a digital camera module in accordance with a first preferred embodiment of the present invention; and

FIG. 2 is a schematic diagram of electrical and physical relationships between components of a digital camera module in accordance with a second preferred embodiment of the present invention.

### DETAILED DESCRIPTION OF THE INVENTION

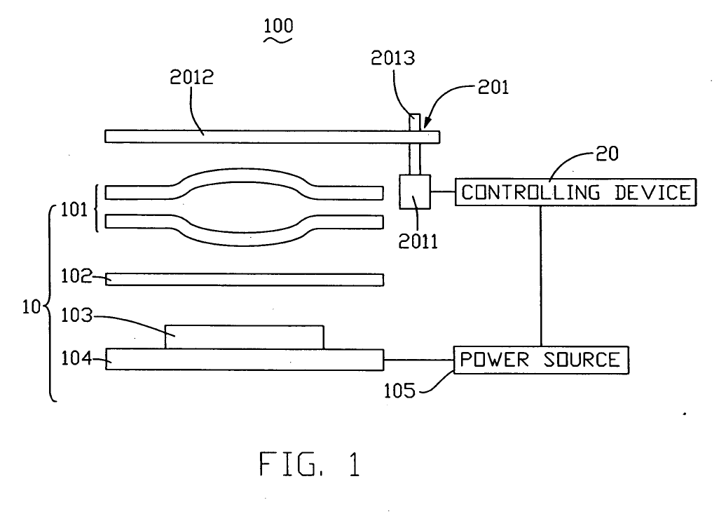

Referring to FIG. 1, a picture/image-taking module like a digital camera module 100 in accordance with the first preferred embodiment of the present invention is used in a portable electronic device such as a mobile phone. The digital camera module 100 includes an image-obtaining device 10, a controlling device 20, and a shielding apparatus 201. The shielding apparatus 201 is set in front of the image-obtaining device 10. The controlling device 20 is electrically connected with both the image-obtaining device 10 and the shielding apparatus 201.

The image-obtaining device 10 includes a pair of lenses 101, a filter 102, an image sensor 103, a printed circuit board 104, and a power source 105. The lenses 101 are provided in front of the image sensor 103. More than a pair of lenses 101 can be provided if desired. The filter 102 is provided between the lenses 101 and the image sensor 103, for reducing the amount of red light that reaches the image sensor 103. The image sensor 103 is a CCD (Charge Coupled Device) sensor or a CMOS (Complementary Metal Oxide Semiconductor) sensor, and is attached on the printed circuit board 104 for transforming optical signals into electronic signals. The power source 105 is electrically connected with and provides power to the printed circuit board 104. It is to be understood that, in practice, the image-obtaining device 10 can also be provided with other suitable structures known in the art.

The shielding apparatus 201 includes a motor 2011, a covering 2012 made of opaque material, and an arbor 2013. The motor 2011 is electrically connected with the controlling device 20. One end of the arbor 2013 is rotatably mounted on the motor 2011, and an opposite end of the arbor 2013 is attached to the covering 2012. In its normal position, the covering 2012 does not cover the image-obtaining device 10. However, when the motor 2011 is activated, the arbor 2013 is rotated so that the covering 2012 covers the image-obtaining device 10.

The controlling device 20 is electrically connected with the motor 2011 and the power source 105 in series. The controlling device 20 can switch the circuit between the motor 2011 and the power source 105 on or off. That is, the controlling device 20 controls the electrical energy supply from the power source 105 to the motor 2011, and thus controls rotation of the motor 2011. The controlling device 20 includes an adjustable timer (not shown), a transceiving module (not shown) and an alarm module (not shown), and recognizes an identity code such as the phone number or another unique number of the mobile phone. The controlling device 20 transforms the identity code and the working status of the controlling device 20 into high frequency signals, and transmits the signals. The controlling device 20 also receives signals, and can be trigger an alarm in response to received signals.

In use of the digital camera module 100, a typical application environment is described as follows. A surveillance apparatus (not shown) is installed in a place where photo taking is forbidden, such as an art gallery. The surveillance apparatus can receive and transmit radio frequency signals, and can analyze received signals and detect the absence of signals previously received. When the surveillance apparatus detects abnormal signals or the improper absence of signals, it triggers an alarm.

Normally, the photo-taking function of the digital camera module is enabled, and the controlling device 20 is switched off at this time. When the user of the mobile phone comes to the art gallery, a guard employed at the entrance to the art gallery can switch the controlling device 20 on. The power source 105 provides power to the motor 2011, the motor 2011 is activated and rotates the arbor 2013, and the arbor 2013 rotates the covering 2012 in a first direction until the covering 2012 covers the lenses 101 of the image-obtaining device 10. In this position, virtually no external light can reach the image-obtaining device 20. Thus the photo-taking function of the digital camera module 10 is ineffectual. At the same time, the guard enters the identity code of the mobile phone into the surveillance apparatus. From this time on, the controlling device 20 periodically transmits signals on the working status (i.e., “ineffectual”) of the mobile phone to the surveillance apparatus.

The user can turn on the adjustable timer, and set a time limit. When the adjustable timer reaches the time limit, the controlling device 10 automatically switches on the circuit between the power source 105 and the motor 2011. The power source 105 provides power to the motor 2011 again, the motor 2011 is activated and rotates the arbor 2013, and the arbor 2013 rotates the covering 2012 in a second direction opposite to the first direction until the covering 2012 is rotated completely away from covering the image-obtaining device 10. Thus the image-obtaining device 10 is returned to its normal status, and the photo-taking function of the digital camera module 100 is effectual again. Immediately, because the controlling device 20 is still switched on, the transceiving module transforms the identity code and the new working status of the controlling device 20 into high frequency signals, and transmits the signals to the surveillance apparatus. The surveillance apparatus receives and analyzes the broadcast signals. Because the signals indicate that the photo-taking function of the digital camera module 100 is effectual, the surveillance apparatus immediately activates an alarm and sends alarm signals to the controlling device 20. The alarm module of the controlling device 20 is thus triggered, and sounds an alarm. The present invention makes it easy for a member of staff of the art gallery to find the mobile phone that has an unauthorized effectual photo-taking capability. When the user leaves the art gallery, the guard deletes the identity code of the mobile phone from the surveillance apparatus. Thereafter the surveillance apparatus cannot monitor and control the photo-taking function of the digital camera module 100 any more.

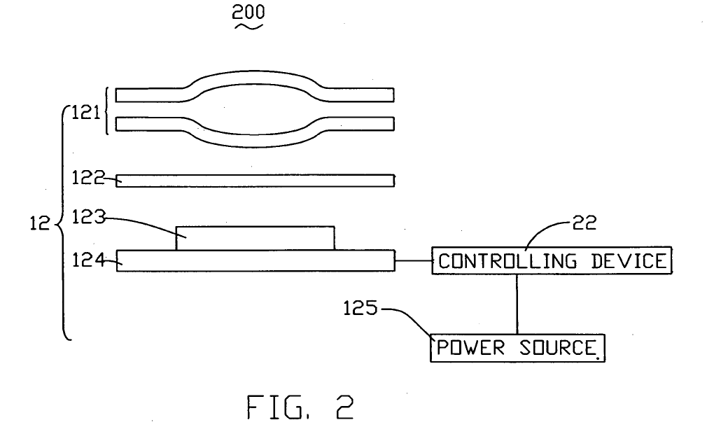

Referring to FIG. 2, a digital camera module 200 in accordance with the second preferred embodiment of the present invention includes an image-obtaining device 12, and a controlling device 22. The controlling device 22 is electrically connected with the image-obtaining device 12.

The image-obtaining device 12 has a structure similar to that of the image-obtaining device 10 of the first embodiment. The image-obtaining device 12 includes a pair of lenses 121, a filter 122, an image sensor 123, a printed circuit board 124, and a power source 125. The lenses 121 are provided in front of the image sensor 123. More than a pair of lenses 121 can be provided if desired. The filter 122 is provided between the lenses 121 and the image sensor 123, for reducing the amount of red light that reaches the image sensor 123. The image sensor 123 is a CCD sensor or a CMOS sensor, and is attached on the printed circuit board 124 for transforming optical signals into electronic signals. The power source 125 is electrically connected with and provides power to the printed circuit board 124.

The controlling device 22 is electrically connected with the printed circuit board 124 and the power source 10 in series. The controlling device 22 can switch the circuit between the printed circuit board 124 and the power source 125 on or off. When the controlling device 22 is switched on, the power source 125 stops providing power to the printed circuit board 124, and thus the photo-taking function of the digital camera module 200 cannot be operated. The controlling device 22 includes an adjustable timer (not shown), a transceiving module (not shown), and an alarm module (not shown), and recognizes an identity code such as the phone number or another unique number of the mobile phone. The controlling device 22 transforms the identity code and the working status of the mobile phone into high frequency signals, and transmits the signals. The controlling device also receives signals, and can be trigger an alarm in response to received signals.

In use of the digital camera module 200, a typical application environment is described as follows. A surveillance apparatus (not shown) is installed in a place where photo taking is forbidden, such as an art gallery. The surveillance apparatus can receive and transmit radio frequency signals, and can analyze received signals and detect the absence of signals previously received. When the surveillance apparatus detects abnormal signals or the improper absence of signals, it triggers an alarm.

Normally, the photo-taking function of the digital camera module 200 is enabled, and the controlling device 22 is switched off at this time. When the user of the mobile phone comes to the art gallery, a guard employed at the entrance to the art gallery can switch the controlling device 22 on. The power source 125 stops providing electrical energy to the printed circuit board 124. Thus the photo-taking function of the digital camera module 200 is ineffectual. At the same time, the guard enters the identity code of the mobile phone into the surveillance apparatus. From this time on, the controlling device 22 periodically transmits signals on the working status (i.e., “ineffectual”) of the mobile phone to the surveillance apparatus.

The user can turn on the adjustable timer, and set a time limit. When the adjustable timer reaches the time limit, the power source 125 automatically starts to provide power to the printed circuit board 124. Thus the image-obtaining device 12 is returned to its normal status, and the photo-taking function of the digital camera module 200 is effectual again. Immediately, because the controlling device 22 is still switched on, the transceiving module transforms the identity code and the new working status of the controlling device 22 into high frequency signals, and transmits the signals to the surveillance apparatus. The surveillance apparatus receives and analyzes the broadcast signals. Because the signals indicate that the photo-taking function of the digital camera module 200 is effectual, the surveillance apparatus immediately activates an alarm and sends alarm signals to the controlling device 22. The alarm module of the controlling device 22 is thus triggered, and sounds an alarm. The present invention makes it easy for a member of staff of the art gallery to find the mobile phone that has an unauthorized effectual photo-taking capability. When the user leaves the art gallery, the guard deletes the identity code of the mobile phone from the surveillance apparatus. Thereafter the surveillance apparatus cannot monitor and control the photo-taking function of the digital camera module 200 any more.

In both digital camera modules 100, 200, when the controlling device 20, 22 is switched on, the photo-taking function is ineffectual. It is possible for the user to switch off the controlling device 20, 22 himself/herself, and thus make the digital camera module 100, 200 effectual. However, if the adjustable timer has been turned on and has not yet reached the time limit, the user cannot switch off the controlling device 20, 22 himself/herself. If the user switches off the controlling device 20, 22 himself/herself, for example in a case when the adjustable timer has not been turned on at all, the surveillance apparatus detects the absence of the signals previously transmitted periodically. The surveillance apparatus accordingly triggers its alarm, and sends alarm signals to trigger the alarm module of the digital camera module 100, 200.

It is to be understood that if the digital camera module 100, 200 is used in a portable electronic device such as a mobile phone or a PDA, the transceiving module of the controlling device 20, 22 can be incorporated as part of the normal antenna device of the portable electronic device. Further, the alarm module of the controlling device 20, 22 can be incorporated as part of the normal voice module of the portable electronic device.

Unlike conventional digital camera modules, the digital camera module 100, 200 of the present invention helps prevent unauthorized use thereof. When the controlling device 20, 22 is switched on, the image-obtaining device 10, 12 is effectively disabled.

It is believed that the present invention and its advantages will be understood from the foregoing description, and it will be apparent that various changes may be made thereto without departing from the spirit and scope of the invention or sacrificing all of its material advantages. The examples hereinbefore described are merely preferred or exemplary embodiments of the invention.

1. A digital camera module for a portable electronic device, comprising:
an image-obtaining device for obtaining images, the image-obtaining device comprising a printed circuit board with an image sensor attached thereon;
a power source;
a shielding apparatus comprising a motor electrically connected with said power source, and an arbor rotatably mounted on said motor and attached to a covering, wherein
said covering is rotated by said arbor when said motor is activated; and
a controlling device electrically connected with said power source and said motor in series, the controlling device controlling power supply from said power source to said motor.

2. The digital camera module as claimed in claim 1, wherein said covering is made of opaque material.

3. The digital camera module as claimed in claim 1, wherein said controlling device recognizes a unique identity code associated with the digital camera module.

4. The digital camera module as claimed in claim 3, wherein said identity code is the phone number of a mobile phone incorporating the digital camera module.

5. The digital camera module as claimed in claim 3, wherein said controlling device comprises an adjustable timer, a transceiving module and an alarm module, said adjustable timer can set a time limit until which said covering covers the image-obtaining device, said transceiving module transforms both said identity code and a working status of said controlling device into high frequency signals and transmits the signals, said transceiving module can also receive signals, and said alarm module can trigger an alarm in response to received signals.

6. A digital camera module for a portable electronic device, comprising:
an image-obtaining device for obtaining images, the image-obtaining device comprising a printed circuit board with an image sensor attached thereon;
a power source; and
a controlling device electrically connected with said image-obtaining device and said power source in series, wherein controlling device controls power supply from said power source to said image-obtaining device.

7. The digital camera module as claimed in claim 6, wherein said controlling device recognizes a unique identity code associated with the digital camera module.

8. The digital camera module as claimed in claim 7, wherein said identity code is the phone number of a mobile phone incorporating the digital camera module.

9. The digital camera module as claimed in claim 7, wherein said controlling device further comprises an adjustable timer, a transceiving module and an alarm module, said adjustable timer can set a time limit until which the image-obtaining device is disabled, said transceiving module transforms both said identity code and a working status of the controlling device into high frequency signals and transmits the signals, said transceiving module can also receive signals, and said alarm module can trigger an alarm in response to received signals.

10. A method for use control of a picture/image-taking module, comprising the steps of:
providing said module in a workable situation;
setting up a controlling device around said module; and
disabling said module by means of said controlling device in case that said controlling device is activated when said module is moved in a predetermined area.

11. The method as claimed in claim 10, wherein said controlling device cuts off a power supply of said module in said disabling step.

12. The method as claimed in claim 10, wherein said controlling device blocks said module from acquiring any picture/image-related light in said disabling step.

13. The method as claimed in claim 10, further comprising the step of transmitting an identity code and a current work status of said module to an outside apparatus periodically after said disabling step in case that said module is present in said area.

14. The method as claimed in claim 10, further comprising the step of triggering an alarm after said disabling step in case that said module is present in said area and enabled.
